(19) United States
(12) Patent Application Publication
(10) Pub. No.: US 2009/0171629 A1
(43) Pub. Date: Jul. 2, 2009

(54) NETWORK DIAGRAM DISPLAY DEVICE, PROGRAM AND RECORDING MEDIUM

(75) Inventor: Takashi Hirose, Tokyo (JP)

Correspondence Address: HICKMAN PALERMO TRUONG & BECKER, LLP, 2055 GATEWAY PLACE, SUITE 550, SAN JOSE, CA, 95110, US

(73) Assignee: ITOCHU TECHNO-SOLUTIONS CORPORATION, Tokyo (JP)

(21) Appl. No.: 12/305,629

(22) PCT Filed: Jun. 25, 2007
(86) PCT No.: PCT/JP2007/062661

§ 371 Date: Dec. 18, 2008

(30) Foreign Application Priority Data
Jun. 29, 2006 (JP) 2006-179184

(51) Int. Cl. G06F 17/50

(52) U.S. Cl. 703/1; 715/765

(57) ABSTRACT

Problem to be Solved: A subject matter is to understandably make one drawing for a logical structure diagram and a physical structure diagram.

Means to Solve the Problems: A physical connection between a router 10 and a switch 11 is expressed by drawing a connecting line A from circles (outer circles) indicative of the router 10 and the switch 11. By connecting between an outer circle and an intermediate circle/an inner circle with connecting lines, a logical connection between the router 10 and the switch 11, and one inside the switch 11, can be expressed.

### FIELD OF THE INVENTION

The present invention is related to a network diagram display device, program and recording medium. More particularly, the present invention is related to a network diagram display device, program and recording medium that express both physical structure diagram and logical structure diagram.

### BACKGROUND OF THE INVENTION

Conventionally, as for examples of technologies for creating a network diagram, there are those disclosed in the following Patent Documents 1 and 2.

Patent Document 1 discloses a technology by which even though operators unfamiliar with the technical content of various facilities that constitute a communication network can easily add a symbol figure to the display and allocate a name to it. This technology discloses a multi-window on the display screen of the pattern diagram of the communication network and displays a symbol name allocating screen for allocating a name to the symbol figure to be added to the display. And based on an instruction input, a symbol figure to be displayed on the display screen is additionally displayed and the display control of the screen for allocating a name is performed, and the symbol figures of facilities to be added to the display are read out from a previously stored storage means, and are added to the display at a predetermined position within the pattern diagram of the communication network.

Patent Document 2 discloses a technology that allows the efficient drawing of an easy-to-understand network diagram. This technology enables to choose a position such that the line connecting mutual nodes does not overlap nodes other than the node in which the line is connected to its counterpart, based on the position information of the nodes within the network diagram and the connection information expressing which nodes are connected by the line which connects mutual nodes, and to create a line by which mutually-connected nodes are connected with a straight line or curved line at the chosen position.

Patent Document 1: Japanese Patent Number 3,179,371

Patent Document 2: Japanese Patent Number 2,804,224

### DISCLOSURE OF THE INVENTION

### Problem to be Solved by the Invention

Now, the network diagrams are broadly classified as logical structure diagram and physical structure diagram. In general, someone recommends that the logical structure diagram and the physical structure diagram should be separately drawn.

However, in the case of drawing the logical structure diagram and the physical structure diagram separately, the respective drawings need to be referred when performing the network management. Therefore, even in the case of performing a simple network management such as VLAN (Virtual LAN), the tables of parameters pertaining to the respective drawings need to be referred, making it burdensome.

Consequently, the problem of the present invention is to make it possible to draw the logical structure diagram and the physical structure diagram with only one single drawing, and to draw it easily.

### Means of Solving the Problem

In order to solve the above problem, the network diagram display device of the present invention comprises:

a first display means for displaying various nodes in a manner of allowing the identification of the classification thereof;

a second display means for displaying the physical connection part between the foregoing nodes; and

a third display means for displaying the logical connection part between the foregoing nodes or within the nodes.

In relation to the first and second display means, the physical connection between nodes is expressed by drawing a connecting line from a circle indicative of a node (layer), and the logical connection between nodes and within a node can be expressed by connecting an outer circle and an intermediate circle/an inner circle with a connecting line.

And the program of the present invention makes the computer perform:

a step for displaying various nodes in a manner of allowing the identification of the classification thereof;

a step for displaying the physical connection part between the foregoing nodes; and

a step for displaying the logical connection part between the foregoing nodes.

In addition, the recording medium of the present invention stores the above program.

### EMBODIMENT OF THE INVENTION

Referring to drawings, an embodiment of the present invention will be described hereinafter.

### GENERAL DESCRIPTION

FIG. 1 shows a network diagram created by the embodiment of the network diagram creation device according to the present invention. FIG. 1 shows an example of network diagram that assumes a LAN or WAN connection of an ISP (Internet Service Provider) or a large company, etc.

First, the connection relation of nodes will be described. As shown in FIG. 1, a router 10 that is compliant with the BGP (Border Gateway Protocol) etc. is physically connected to the wide-area Ethernet (registered trademark) A. The router 10 is provided, for example, on the border between the BGP area and the OSPF (Open Shortest Path First) area, and is to exchange the node connection route information as it is known today.

The router 10 is physically connected, for example, with layer 3 switches (L3 switches) 11 and 12 via connecting lines A and C respectively. For example, the connecting lines A and C can be VLAN 3 and VLAN 2 respectively. Notations “0.4” and “0.18” denoted near the respective ends of the connecting lines A and C within the circle indicative of the router 10 mean the IP addresses of the respective routing ports.

Other than this, the “Product name (Router A)” and “the last number of the management IP address (0.254)” of the router 10 is denoted as an example within the circle indicative of the router 10. However, these are not necessarily denoted within the circle indicative of the router 10. Moreover, the denoted subjects shall not be limited to those examples. In so doing, as an example of the last number of the IP address, when the IP address is for example “192.168.1.10/24”, it can be a part such as “0.10” which is identifiable from other IP addresses.

In contrast, “GbE 2/2” etc. denoted near the ends of the connecting lines A and C outside the circle indicative of the router 10 indicates the port number of the router 10. And near the end of the connecting line joining the router 10 and the wide-area Ethernet A, an IP address such as (10.0.0.1) allocated to the router 10 is selectively denoted.

The L3 switch 11 is also physically connected to the L3 switches 12 and 23 via the connecting lines D and B respectively other than the router 10. This embodiment, here, indicates the physical connection between nodes by connecting the ends of the connecting line to the outer circle indicative of each node. In contrast, the logical connection between nodes and within a node is indicated by connecting the outer circle indicative of each node with the inner circle/the intermediate circle. As described hereinbelow, in accordance with the increase in the number of connection ports, new circles indicative of layers can be added to the circle indicative of each node.

The connecting line B indicates a trunk connection transmitting the VLAN 3. The connecting line D indicates a trunk (connection transmitting the VLANs 1 and 4. Same as the case of the router 10, the “Product name (Switch B)”, the management IP address indicated by “.*** (* denotes a specific symbol)”, and others are also selectively denoted inside or outside the circle indicative of the L3 switch 11 etc. In the case of the L3 switch 11, “0.247” means the loopback address, while “0.3”, “0.6” and “0.253” mean the IP addresses of the routing ports. The details of these are described hereinbelow.

The L3 switch 12 is also physically connected to the L3 switch 22 via a connecting line E in addition to the physical connection with the router 10 and the physical connection with the L3 switch 11. The connecting line E indicates a trunk connection transmitting the VLAN 2.

In addition, a router 20 compliant with the BGP etc. is connected to the wide-area Ethernet B similarly on the border between the BGP area and the OSPF area. For example, the router 20 is physically connected to the L3 switches 21, 22 and 23 respectively via connecting lines F, G and H. For example, the connecting lines F, G and H can be VLAN 6, VLAN 2 and VLAN 3 respectively.

The L3 switch 21 is also physically connected to the L3 switch 24 via a connecting line I in addition to the router 20. For example, the connecting line I can be VLAN 6.

The L3 switch 22 is also physically connected to the L3 switch 23 via a connecting line J in addition to the previously-mentioned connection with the router 20 etc., and is also physically connected to the L2 switch 25 and the L2 switch 26 via connecting lines M and L respectively. For example, the connecting lines J, M and L can be a “trunk connection transmitting VLAN 1 and 5”, “VLAN 5” and “VLAN 1” respectively.

The L3 switch 23 is also physically connected to the L2 switch 27 via a connecting line K in addition to the previously-mentioned connections with the router 20 etc. For example, the connecting line K can be VLAN 1.

The L2 switches 25, 26 and 27 are physically connected to servers 28, 29 and 30 via connecting lines N, 0 and P respectively. As described hereinbelow, a router is for example indicated by a single circle, an L2 switch is for example indicated by a double circle, and an L3 switch is for example indicated by a triple circle so that nodes can be identified respectively. In addition, a part that performs routing and a part that does not perform routing are also made identifiable. As is the case of the L3 switch 11 etc., the “Product name (Switch C)” and the port number, etc. are also selectively denoted inside or outside the circle indicative of the L2 switch 25 etc.

Next, notation examples for node etc. will be described. Regarding the router 10 etc., the L3 switch 11 etc. and the L2 switch 25 etc., the classification of node can be made visually on the network diagram by changing the size of the circles, the number of circles, the presence of hatching and color inside the circles, and the thickness of the lines indicative of the outer edges.

In addition, the classification of the connecting lines A to P can be recognized respectively by color-coding the VLANs 1 to 6 and trunk connection, by expressing with a solid line, broken line and dashed line, etc., or by changing the thickness of the lines.

FIG. 2 is a supplemental illustration of the relationship between the 3 L switch and the connecting line as shown in FIG. 1. In order to facilitate understanding, two examples are shown here.

The inner circle indicates a routing layer. It is advantageous that the inner circle indicative of a part that performs routing is made identifiable from a part that does not perform routing by changing its color from those of other circles. In addition, a routing cost denoted as “c” is also indicated for the inner circle.

An arched thick line on the outer circle indicates a VLAN access port group for performing physical connections with other nodes. In the case of FIG. 2(a), two LVAN access port groups a and b are shown. In the case of FIG. 2(b), three LVAN access port groups a, b and c are shown.

A line connected to the VLAN access port group a etc. at one end and extended towards the center of the same node circle up to the intermediate circle at the other end indicates a trunk port permitted VLAN for a logical connection. In the case of FIG. 2(a), two permitted VLANs h and I are shown. In the case of FIG. 2(b), one permitted VLAN j is shown.

A line connected to the VLAN access port group a etc. at one end and extended towards the center of the same node circle up to the inner circle at the other end indicates a logical interface, for example, VLAN interface. In the case of FIG. 2(a), two LVAN interfaces f and g are shown. In the case of FIG. 2(b), three VLAN interfaces g, h and i are shown.

Regarding the parts noted as d, e, j and k in FIG. 2(a) and the parts noted as d, e, f and k in FIG. 2(b), please refer to the explanations of the corresponding parts in FIG. 3.

As described above, the physical connection between nodes is expressed by drawing a connecting line from a circle indicative of a node (layer), and the logical connection between nodes and within a node is expressed by connecting an outer circle and an intermediate circle/an inner circle. For example, in the case of the L3 switch as shown in FIG. 2, a connecting line of a port that transfers data with reference to MAC address is drawn from the outer circle or the intermediate circle. In contrast, a connecting line of a port that performs IP routing is drawn from the inner circle. As a result of the drawing of connecting lines as above, the connection relation of VLAN etc. can be grasped by only following the connecting lines.

FIG. 3 shows an alternative one of the notation examples shown in FIG. 2.

The inner circle means a routing layer 102 of the L3 switch. A denoting area 104 for the “Product name”, “Host name”, “Loopback IP address”, and Component ID (RL****) of the L3 switch is provided inside the inner circle.

The intermediate circle means a VNAN trunk layer 107 of the L3 switch. The VLAN trunk layer 107 is managed by allocating a specific component ID, for example, “VTL****” or the like. The aforementioned component ID may be indicated within the drawing.

The outer circle means a VLAN access layer 110 of the L3 switch. The VLAN access layer 110 is managed by allocating a specific component ID, for example, “VAL****” or the like. Here, the aforementioned component ID is denoted inside the outer circle on the lower side of the drawing.

The dot on the inner circle means, for example, a VLAN routing access port 103 of the L3 switch. The VLAN routing access port 103 is managed by allocating a specific component ID. For example, the component ID may be “RVAP****” or the like. The aforementioned component ID may be indicated near the VLAN routing access port 103 within the drawing.

A line radially extended from the VLAN routing access port 103 (inner circle) means a VLAN interface connection 104 of the L3 switch. The VLAN interface connection 104 is managed by allocating a specific component ID, for example, “VIFC****” or the like. The aforementioned component ID may be indicated somewhere near the VLAN interface connection 104 within the drawing.

A thick line on the VLAN trunk layer 107 (intermediate circle) means a VLAN trunk port group module 111 of the L3 switch. The VLAN trunk port group module 111 is managed by allocating a specific component ID. For example, the component ID may be “VTPG****” or the like. The aforementioned component ID may be indicated near the VLAN trunk port group module 111 within the drawing.

A line radially extended from the VLAN trunk port group module 111 (a thick line on the intermediate circle) means a VLAN permitted connection 108 of the L3 switch. The VLAN permitted connection 108 is managed by allocating a specific component ID, for example, “AVC****” or the like. The aforementioned component ID may be indicated within the drawing.

A thick line on the VLAN access layer 110 (outer circle) means a VLAN access port group 106 of the L3 switch. The VLAN access port group 106 is managed by allocating a specific component ID, for example, “VAPG****” or the like. The aforementioned component ID may be indicated within the drawing.

A dot on the VLAN access port group 106 (a thick line on the outer circle) wherein the dot is connected to the VLAN interface connection 104 means a VLAN access routing port 105 of the L3 switch. The VLAN access routing port 105 is managed by allocating a specific component ID. The specific component ID may be, for example, “VARP****” or the like. The aforementioned component ID may be indicated within the drawing.

A dot on the VLAN access port group 106 (a thick line on the outer circle) wherein the dot is located at one end of a radially extended connecting line means a VLAN access port 109. This is managed by allocating a specific component ID, for example, “VAP****” or the like. Here, a port number is denoted near the VLAN access port 109 within the drawing.

FIG. 4(a) shows a notation example of the L2 switch. FIG. 4(b) shows a notation example of the router. FIG. 4(c) shows a notation example of a hub switch, and each figure corresponds to FIG. 2 and others.

The inner circle shown in FIG. 4(a) means a VLAN trunk layer module 122 of the L2 switch. A denoting area 121 for, for example, the “Product name”, “Host name”, “Loopback IP address”, and “Component ID (VTL****)” of the L2 switch is provided inside the inner circle.

The outer circle means a VLAN access layer 129 of the L2 switch. The VLAN access layer 129 is managed by allocating a specific component ID, for example, “VAL****” or the like. As discussed below, the management of the aforementioned ID etc. is performed by storing and updating the aforementioned ID etc. to the memory etc. within the network diagram creation device. Here, the aforementioned component ID is denoted inside the outer circle on the lower side of the drawing.

A thick line on the VLAN trunk layer module 122 (inner circle) means a VLAN trunk port group module 123 of the L2 switch. The VLAN trunk port group module 123 is managed by allocating a specific component ID. For example, the component ID may be “VTPG****” or the like. The aforementioned component ID may be indicated near the VLAN trunk port group module 123 within the drawing.

A thick broken line and dots on the VLAN access layer 129 (outer circle) mean VLAN access port group modules 127 of the L2 switch. The VLAN access port group modules 127 are managed by allocating a specific component ID, for example, “VAPG****” or the like. The aforementioned component ID may be indicated within the drawing.

The connecting line between the VLAN trunk layer module 122 (a thick line on the inner circle) and the VLAN access port group module 127 (a broken line etc. on the outer circle) means a VLAN permitted connection 125 of the L2 switch. The VLAN permitted connection 125 is managed by allocating a specific component ID, for example, “AVC****” or the like. The aforementioned component ID may be indicated within the drawing.

The dot inside the VLAN permitted connection 125 of the L2 switch means a VLAN trunk access port module 124. The VLAN trunk access port module 124 is managed by allocating a specific component ID. The component ID may be, for example, “VTAP****” or the like. The aforementioned component ID may be indicated near the VLAN trunk access port module 124 within the drawing.

The connection point on the VLAN trunk port group module 123 (a thick line on the inner circle) with a line radially extended towards the outside of the circle (a connecting line with another node) means a VLAN trunk port module 130 of the L2 switch. The VLAN trunk port module 130 is managed by allocating a specific component ID. The component ID may be, for example, “VTP****” or the like. The aforementioned component ID may be indicated near the VLAN trunk port module 130 within the drawing.

A dot at the outer end of the VLAN permitted connection 125 of the L2 switch indicates a VLAN access trunk port module 126. The VLAN access trunk port module 126 is managed by allocating a specific component ID, for example, “VATP****” or the like. The aforementioned component ID may be indicated within the drawing.

The connection point with a line radially extended from the VLAN access port group module 127 (dots on the outer circle) means a VLAN access port module 128 of the L2 switch. The VLAN access port module 128 is managed by allocating a specific component ID, for example, “VAP****” or the like.

The circle shown in FIG. 4(b) means a routing layer module 152. A denoting area 151 for, for example, the “Product name”, “Host name”, “Loopback IP address”, and “Component ID (RL****)” is provided inside the circle.

A dot on the routing layer module 152 (circle) means a routing port module 153 of the router. The routing port module 153 is managed by allocating a specific component ID, for example, “RP****” or the like.

The circle shown in FIG. 4(c) means a hub layer module 143 of the hub switch. A denoting area 141 for, for example, the “Product name”, “Host name”, “Management IP address”, and Component ID (HL****) is provided inside the circle.

Dots on the hub layer module 143 (circle) means a hub access port group module 142 of the hub switch. The hub access port group module 142 is managed by allocating a specific component ID, for example, “HAG***” or the like.

The connection point on the hub access port group module (dots) 142 with a connecting line extended towards the outside means a hub access port module 144 of the hub switch. The hub access port module 144 is managed by allocating a specific component ID, for example, “HAP***” or the like.

FIG. 5 shows a screen interface of the network diagram creation device which creates the network diagram shown in FIG. 1. As shown in FIG. 5, a toolbar area 200 including operation tools such as “File” and “Edit” is displayed on the upper part of the display. A stencil area 300 is located on the left side of the screen below the toolbar area 200.

The stencil area 300 shows a router icon 301, L3 switch icon 302, L2 switch icon 303, . . . , VLAN access layer icon 304, and VLAN trunk layer icon 305, etc. in order to display drawing subjects within an after-mentioned network diagram area 400. The stencil area 300 also prepares other icons that are not shown including port icons for VLAN access port or VLAN trunk port etc. and connecting line icons for VLANs etc. in addition to these icons 301 to 305.

The other icons can be displayed on the stencil area 300 by operating a scroll bar 306. In one of ways, each of the icons 301 etc. may be displayed in the network diagram area 400 by dragging and dropping into the network diagram area 400. The display control can be performed with those generally used for image processing such as vector control and sprite control.

The network diagram area 400 displays an L3 switch (Node1) 401, L3 switch (Node2) 403 and L3 switch (Node3) 404 that are drawn by dragging and dropping the L3 switch icon 302. The L3 switch 401 and the L3 switch 403 are connected mutually by a connecting line 406 at the respective outer circles, while the L3 switch 403 and the L3 switch 404 are connected mutually by a connecting line 407 at the respective outer circles. Here, the classification of the connecting line 406 etc. can be modified, for example, by bringing the cursor over the connecting line 406 etc. and then right-clicking etc.

The L3 switch 401 is appended with an edit menu display area 402 for the specific IP address etc. described with reference to FIG. 2 etc. The edit menu display area 402 is made to display by an operation of bringing the cursor over the L3 switch 401 and then right-clicking etc. The contents displayed in the edit menu display 402 are menu items to perform, for example, the process of adding node icons to the network diagram area 400, the process of editing the network diagram, and the process of modifying the network diagram etc., and thus those are menu items to perform the setting of various setting items shown in an after-mentioned parameter area 500. When any of the menu items is selected in the display area 402, a pop-up input screen 408, for example, is displayed as described with reference to FIG. 6, allowing input to various settings. In addition, the display area 402 may prepare a select menu item to execute the drawing of connecting lines.

The number of layers of the L3 switch 404 can be increased by dragging and dropping the VLAN access layer icon 304 or the VLAN trunk layer icon 305 etc. for the L3 switch 404. When actually increasing the number of layers, the L3 switch 404 will show, for example, just like the L3 switch 405. That means, when the number of connection ports for the L3 switch increases, the network diagram can be expanded by increasing the number of the layers. Although the number of layers can be increased by dragging and dropping the VLAN access layer icon 304 etc. from the stencil area 300, it can also be handled by increasing the number of connection ports.

In addition, the network diagram area 400 shows a selection area 410 for selecting a display type of the network diagram. FIG. 5 shows a status that the “Physical, logical” type has been selected. The display modes wherein the “Physical diagram” type or the “Logical diagram” type has been selected will be described later.

A parameter area 500 is located on the right side of the network diagram area 400. The parameter area 500 shows a tub area 508 including a “Node parameter tub”, “Equipment list tub” pertaining to a list that extracts information within the “Node parameter tub” by categories, “IP address information list tub”, “VLAN information list tub”, and “ACL (Access Control List) information list tub”.

Here, the tub area 508 shows a status wherein the “Node parameter tub” has been selected. In addition, FIG. 5 shows a status wherein the L3 switch 401 (Node1) within the network diagram area 400 is framed in a square, and “Node1” in a selected subject display area 506 within the parameter area 500 is displayed in bold, meaning that the setting subject of the basic setting is the L3 switch 401.

In the “Node parameter tub”, a selection area 507 is shown for selecting a setting subject from pull-down including the basic setting to input “Host name” etc., the VTP setting to input (VLAN Trunking Protocol) version information etc., the STP setting to input the classification etc. of the STP (Spanning Tree Protocol), the routing setting to input information regarding static information such as destination network etc., and the routing setting regarding the RIP (Routing Information Protocol) such as version information etc.

Here, the selection area 507 shows a display example wherein the basic setting has been selected. When the “Basic setting” is selected, input fields for the “IOS (Internetworking Operating System) version”, “Management IP address”, “Enable password”, and “Login password” etc. will be displayed in addition to the “Host name”, so that users may just input the required information in each field.

On the right side of the parameter area 500, a config area 600 with an input field 601 for configuration information is located. The config area 600 assumes a case that the L3 switch 401 (Node1) has been selected as is the case of the parameter area 500. A selected subject display area 602 within the config area 600 shows a status wherein “Node1” is displayed in bold.

In fact, it also prepares an estimation sheet area for displaying a parameter sheet corresponding to estimation equipment, and an alarm area for informing the network manager of any detection of abnormality in the network and the classification etc. of its abnormality, in addition to the parameter area 500 and config area 600 as shown in FIG. 5, composing the area of display subjects in a configurable manner in accordance with user instructions.

FIG. 6 is an illustration of another operation example of the screen interface shown in FIG. 5. In FIG. 6, like numerals denote like parts shown in FIG. 5.

FIG. 6 shows a pop-up input screen 408 which is displayed when any of the menu items is selected in the display area 402 shown in FIG. 5, and a pop-up input screen 409 which is displayed when the VLAN access layer icon 304 etc. is dragged and dropped into the network diagram area 400.

The pop-up input screen 408 shows an example of the case that the “Physical connection” has been selected among the menu items in the display area 402. The pop-up input screen 408 shows a non-limiting example of the input screen of port numbers of any nodes (NodeA, NodeB), and can also be, for example, an input screen etc. of information regarding connecting lines.

The pop-up input screen 409 shows an example of the input screen of the Node name, Product name and IP address pertaining to the VLAN access layer icon 304. The pop-up input screen 409 is preferably those allowing the input of various kinds of information attached to the node shown in FIG. 1 etc as above.

FIG. 7 shows a display example of the case that the “VLAN filter” has been selected among the menu items of the display area 402 shown in FIG. 5. In FIG. 7, it shows a status wherein the display configuration shown in FIG. 5 with the network diagram area 400, parameter area 500 and config area 600 has been changed to a display configuration with the network diagram area 400. Similarly, a display configuration with only a different display area or with any combination thereof is configurable.

When the “VLAN filter” is selected in the display area 402, a pop-up display appears to show a display area 402′ allowing the selection of the VLAN number and VLAN ID etc. that are wanted to be filtered.

When the VLAN filter is disabled, relatively many access groups are displayed as indicated by the numeral 430. In contrast, when the VLAN filter is enabled, the access groups pertaining to the VLAN number etc. selected in the display area 402′ are filtered, and relatively few access groups are displayed as indicated by the numeral 440.

FIG. 8 to FIG. 10 show each other's display status when the selected subject is changed in the selection area 410 within the network diagram area 400.

FIG. 8 shows a display example wherein the “Physical, logical” has been selected. This display example corresponds to that shown in FIG. 1 etc. That means, the nodes are indicated by one or two or even more circles in accordance with its classification, and the display of the connecting lines between nodes also corresponds to its classification, while the physical connection and logical connection between nodes are displayed in an identifiable manner.

Specifically, nodes 411 and 412 indicate routers; a node 413 indicates an L3 switch, and nodes 414 and 415 indicate L2 switches. In addition, a connecting line 416 indicates VLAN3, a connecting line 417 indicates VLAN5, connecting lines 418 and 419 indicate VLAN1, and connecting lines 420 and 421 indicate trunk connections. Furthermore, the nodes 413 and 415 indicate a status not only with physical connections but also with logical connections.

FIG. 9 shows a display example wherein the “Physical diagram” has been selected. This display example displays the icons of router, L3 switch and L2 switch, and also displays connecting lines 416 to 421 in a manner that the VLAN classifications of those cannot be identified mutually.

FIG. 10 shows a display example wherein the “Logical diagram” has been selected. This display example displays the icons of router, L3 switch and L2 switch, and also displays connecting lines 416 to 421 in a manner that the VLAN classifications of those can be identified mutually. Instead of or along with displaying in a manner that the VLAN classification can be identified, each of the connecting lines 416 to 421 may be denoted with its own IP segment such as, for example, 192.168.1.0/24.

(Explanation of Operation)

FIG. 11 shows a flowchart indicative of the CPU's operation of the network diagram creation device which creates the display screen shown in FIG. 5. Please note that even though the operation example shown here is so-called push-type, pull-type operations shall not be construed to be excluded. It is also possible to process in the multi-task system. A program that realizes this operation example in cooperation with a personal computer may be stored in a recording medium so that the program stored in the aforementioned recording medium may be executed by the personal computer.

As shown in FIG. 11, the CPU first determines whether or not an instruction input has been made by the user (Step S1). As a result of the determination, if an instruction input has not been made by the user, it will become an instruction waiting status. In contrast, if an instruction input has been made by the user, the determination process of the instruction content will be executed (Step S2).

In an example shown in FIG. 11, the instruction content being inputted by the user will be broadly divided into, for example, the following three categories.

(1) Steps S81 to S17 show process operations when the user drags and drops an icon image into the network diagram area 400.

(2) Steps S21 to S22 show process operations when the user inputs information to the input fields in the parameter area 500 etc.

(3) Steps S31 to S35 show process operations when the user draws a connecting line between node icons in the network diagram area 400.

As a result of the determination, if the instruction content is such that a dragging of any icon in the stencil area 300 was initiated by a mouse operation etc., the CPU will initiate a moving process of the icon image (Step S11).

Subsequently the CPU will continue the moving process of the icon image until it detects a releasing of the mouse click etc., however when it detects a releasing of the click, it means that a dropping process has been made, thus the moving process of the aforementioned icon image will be terminated (Step S12).

The icon image is usually considered to be dropped at a required position in the network diagram area 400. However there are various kinds of icons such as a switch icon, layer icon and port icon.

Here, as explained about the nodes 404 and 405 with reference to FIG. 5, when a layer icon is dropped on a node icon, a display process is executed in such a way that the number of the layers increases in the display.

In contrast, if a node icon is dropped on a node icon, it is considered to be an operational error from a technical point of view, thus the display process of overlaying the node icon on the other node icon should not be processed.

Therefore, this embodiment performs the following display process. Specifically, the CPU first determines whether or not the drop position of the target icon image to be moved is on another icon image (Step S13). As a result of the determination, if the target icon image to be moved is not on another icon image, it proceeds to Step S17.

In contrast, if the drop position of the target icon image to be moved is on another icon image, the CPU determines whether or not a port icon image or a layer icon image is dropped on a node icon image or a layer icon image (Step S14).

As a result of the determination, if a port icon image etc. has not been dropped on a node icon image etc., in other words, if a node icon image etc. has been dropped on another node icon image etc., the CPU executes a slide process which slides the stop position of the dropped node icon image (Step S15).

Here, the above slide process can be executed by managing and controlling the position of the icon image by, for example, the X-Y coordinate. That means, the above slide process is executed by comprising, for example, a database for storing the classification information of the icon images already located on the network diagram area 400 and the position information indicative of the center coordinate and size etc. thereof; a storage means for storing the above classification and position information to the database; a searching means for searching each of these information from the database; a calculation means for calculating the slide distance of the aforementioned node icon based on the position information of the node icon image searched by the searching means; and a slide means for sliding the icon image in accordance with a result of the calculation by the calculation means.

The above database also stores the position information of the cursor by the storage means. In addition, the size of an icon image can be managed by the information indicative of the coordinate amount corresponding to its radius.

In contrast, if a port icon image etc. is dropped on a node icon image etc. by manual operation, it is usually considered rare that a port icon image is located in a state of being aligned to the outer edge etc. of a circle indicative of a node icon, thus the CPU executes a fitting process by using a snap function so that the port icon image etc. is fitted to the outer edge of the node icon image (Step S16).

Subsequently a process of confirming the drop position of the target icon image to be moved is executed (Step S17).

As above, the process operation proceeds when an icon image is dragged and dropped to create a network diagram by the user.

In addition, as a result of the determination process of Step S2, if the instruction content is such that the node 401 has been selected and the “Node parameter tub” in the parameter area 500 has been selected, the CPU will perform a display switching of the tab by a known technique.

For example, subsequently the basic setting of the “Node parameter tab” is selected by operating a mouse etc. by the user, and if it is determined that a required character information has been inputted by the user through a keyboard by pointing with the cursor at an input field such as the “Host name”, the CPU executes a character information storage process which stores the character information to a memory etc. (Step S21).

Specifically, headings such as the “Host name”, “ISO version”, “Management IP address”, “Enable password” and “Login password”, and the character information corresponding thereto will be coordinated and stored.

Next, the CPU executes a character information display process which displays the character information inputted by the user to the input fields of the parameter area 500 and the circles etc. indicative of respective nodes in the network diagram area 400 (Step S22).

The input fields of the parameter area 500 may be handled at the timing that the above storage process is executed by the user confirmation of the input content. In addition, the host name etc. may be displayed to each node in the network diagram area 400 by executing the process of reading out and displaying the corresponding information stored in the memory etc. Therefore, when the character information inputted by the user is modified etc., the information stored to the memory etc. will be updated, thus the updated results will be reflected in the display.

When an instruction to display the “IP address information list tab” etc. other than the “Node parameter tab” in the tab area 508 was made, the CPU identifies the aforementioned tab and performs a process of displaying after reading out the character information regarding the aforementioned tab from the memory and then performing an embedding operation for the corresponding part of the list.

As above, it is the process operation when the user inputs information to the input fields within the parameter area 500 etc.

In addition, as a result of the determination process of Step S2, if the instruction content is such that the execution of the drawing of a connecting line has been selected among the menu items of the display area 402, the CPU will display the end point of a connecting line on the port icon image specified by the user through a mouse etc. (Step S31).

Next, the CPU will draw, for example, a linear connecting line from the aforementioned end point by following the movement of the cursor by the user. And then, when the cursor is positioned over another port icon image or otherwise within a predetermined distance with reference to another port icon image, a drawing process of informing the user of a terminable port icon image for the connecting line will be executed (Step S32).

Specifically, when the above-described calculation means calculated that the difference between the position information of the cursor and the position information of another port icon image corresponds to a predetermined distance, changing of the above display color etc. may be performed.

Subsequently, the above drawing process will be executed until the user performs a click operation on a desired port icon image. In contrast, when the user performs the click operation on a desired port icon image and the CPU actually detects it, the CPU will perform a fitting process similar to Steps S16 and S17 (Step S34) and will execute a position confirmation process (Step S35).

(Explanation of Configuration)

FIG. 12 shows a functional block diagram of the CPU 1000 which executes the operations etc. shown in FIG. 11. The CPU 1000 comprises a determination means 1010 to execute the process of Step S2; an image position moving means 1020 to execute the process of Step S11 when the determination means 1010 determines that the user initiated a drag process of an icon image; an image position determination means 1030 to execute the process of Steps S13 and S14 after the image position moving means 1020 moved the icon image; and an image position adjustment means 1040 to selectively execute the process of Steps S16 and S17 or Steps S34 and S35 after the drawing of a connecting line was initiated by a result of the determination of the image position determination means 1030 or by an after-mentioned image drawing means 1060.

In addition, the CPU 1000 comprises a character information storage means 1070 to execute the process of Step S21 when the determination means 1010 determines that the user initiated the information input for parameters etc.; a character information display means 1080 to execute the process of Step S22 based on the character information stored in the memory etc. by the character information storage means 1070; and the image drawing means 1060 to execute Steps S31 and S32 when the determination means 1010 determines that the user initiated the drawing process of a connecting line.

Although the above embodiment has been explained with an example of a network diagram that assumes an in-house LAN, network diagrams that can be created by the network diagram creation device shall not be limited to this.

Network diagrams larger or smaller than in-house LAN can be created, and the icons prepared in the stencil area 300 can also be diversified.

Specifically, network diagrams regarding, for example, MPLS (Multi-Protocol Label Switching), GMPLS (Generalized Multi-Protocol Label Switching), RPR (Resilient Packet Ring) and wireless networks can be created. In the case of, for example, GMPLS, circles corresponding to WDM MUX/DEMUX layer, GMPLS layer, WDM Wavelength layer, TDM access layer, TDM external connection layer, and TDM internal connection layer may be displayed.

### BRIEF DESCRIPTION OF THE DRAWINGS

FIG. 1 shows a network diagram created by the embodiment of the network diagram creation device according to the present invention.

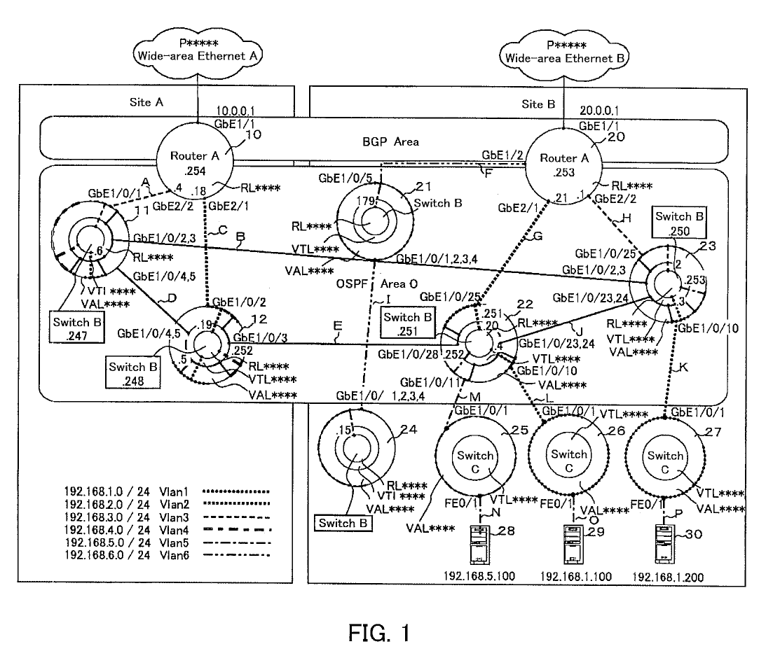

FIG. 2 is a supplemental illustration of the relationship between the 3 L switch and the connecting line as shown in FIG. 1.

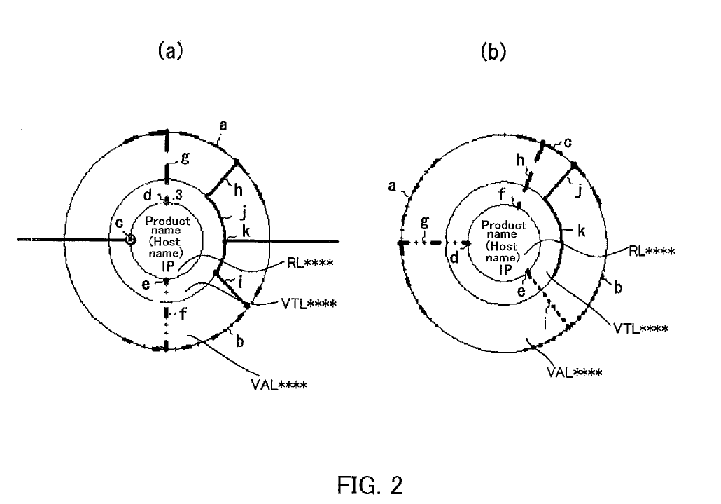

FIG. 3 shows an alternative example of the notation examples shown in FIG. 2.

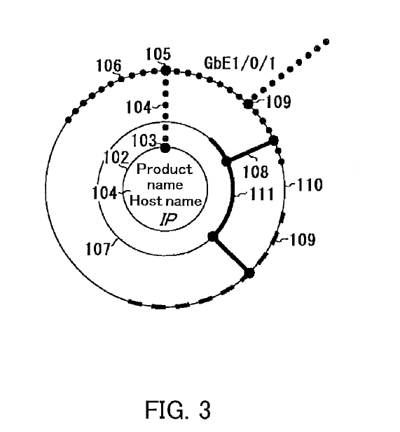

FIG. 4 shows notation examples of the L2 switch, router and hub switch.

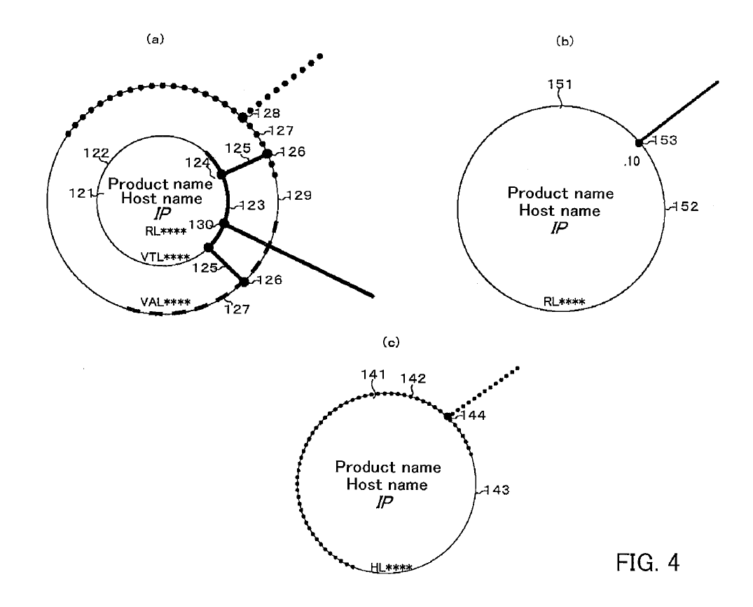

FIG. 5 shows a screen interface of the network diagram creation device which creates the network diagram shown in FIG. 1.

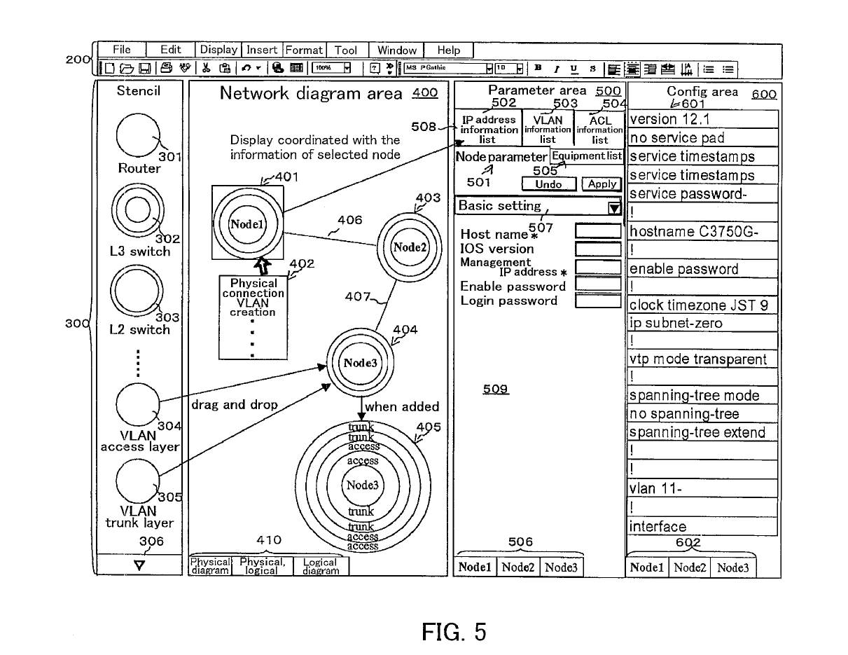

FIG. 6 is an illustration of another operation example of the screen interface shown in FIG. 5.

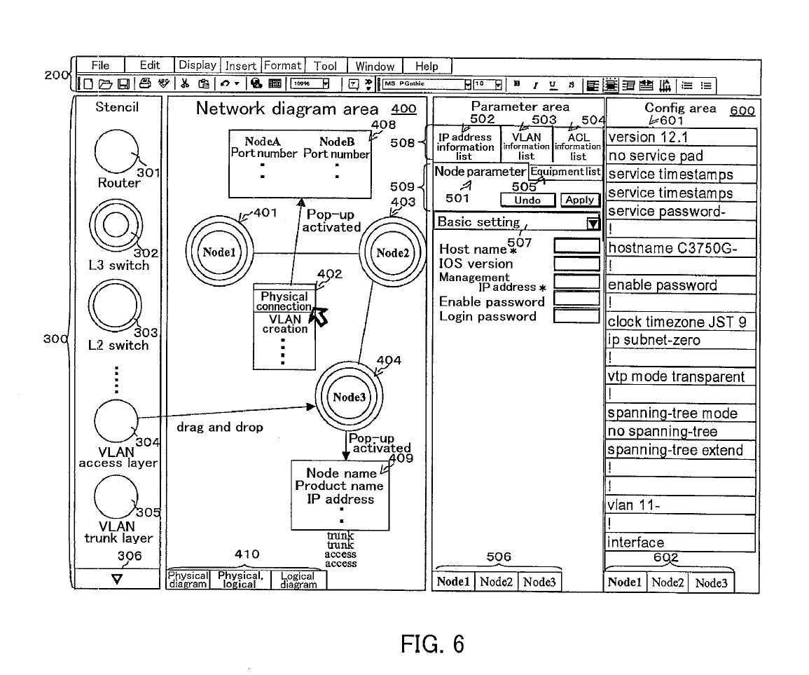

FIG. 7 shows a display example of the case that the “VLAN filter” has been selected among the menu items of the display area 402 shown in FIG. 5.

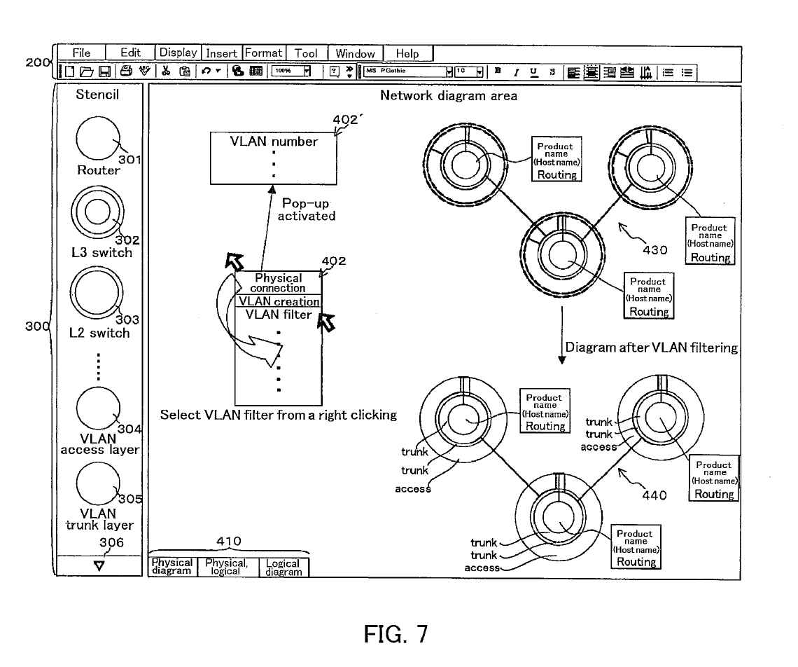

FIG. 8 shows each other's display status when the selected subject is set to the “Physical, logical” in the selection area 410 within the network diagram area 400.

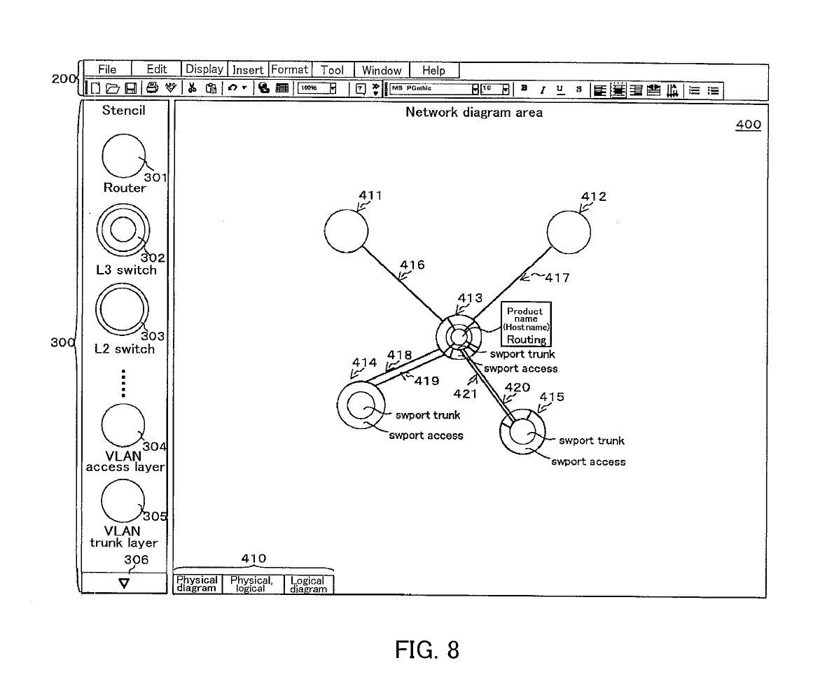

FIG. 9 shows each other's display status when the selected subject is set to the “Physical diagram” in the selection area 410 within the network diagram area 400.

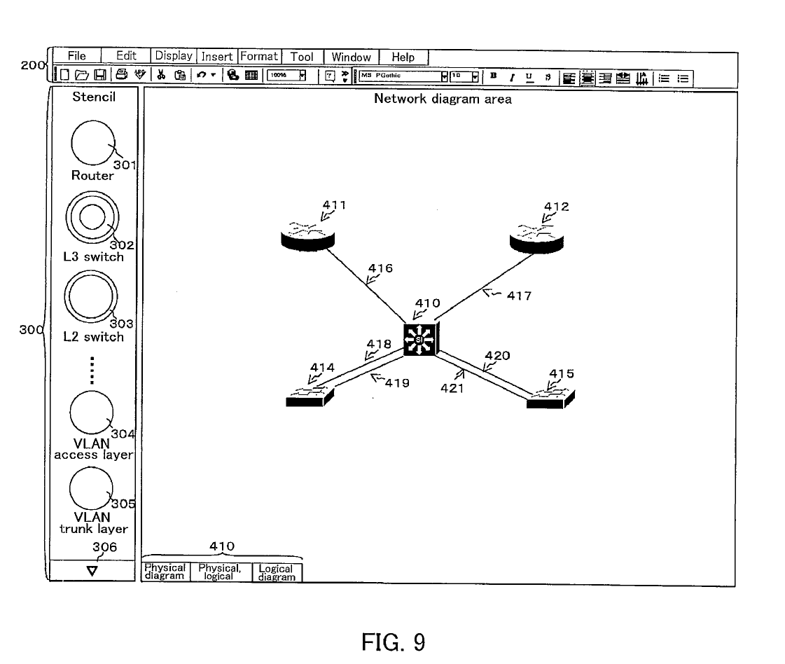

FIG. 10 shows each other's display status when the selected subject is set to the “Logical diagram” in the selection area 410 within the network diagram area 400.

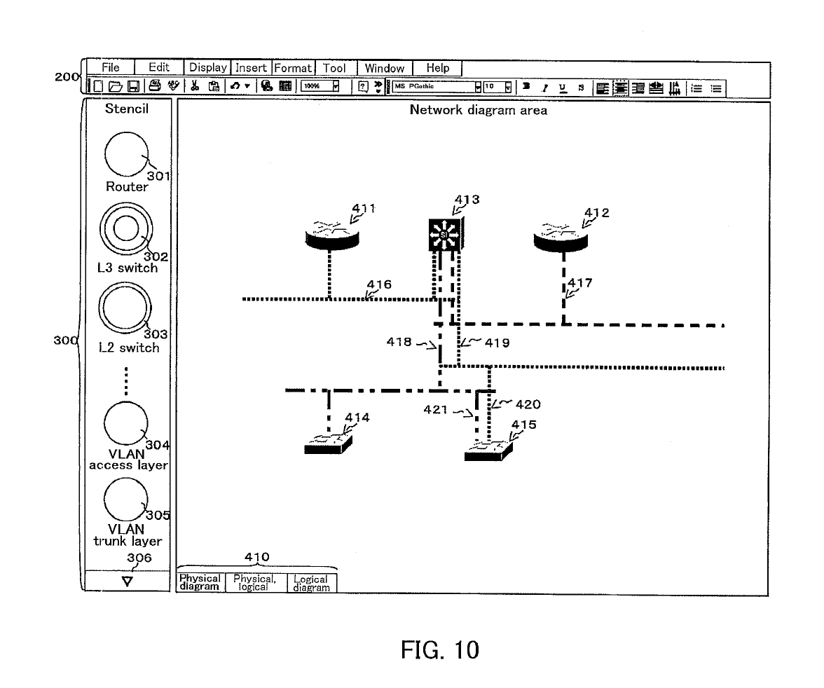

FIG. 11 shows a flowchart indicative of the CPU's operation of the network diagram creation device which creates the display screen shown in FIG. 5.

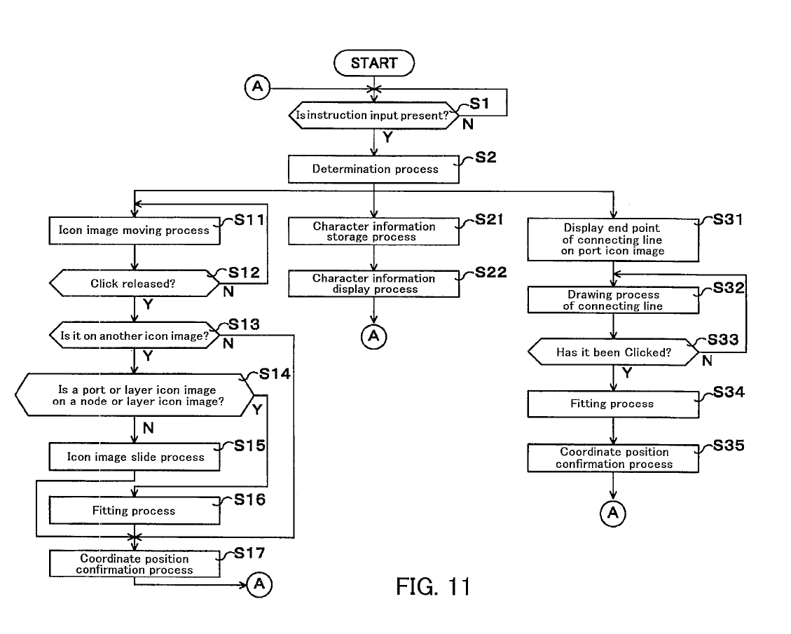

FIG. 12 shows a functional block diagram of the CPU 1000 which executes the operations etc. shown in FIG. 11.

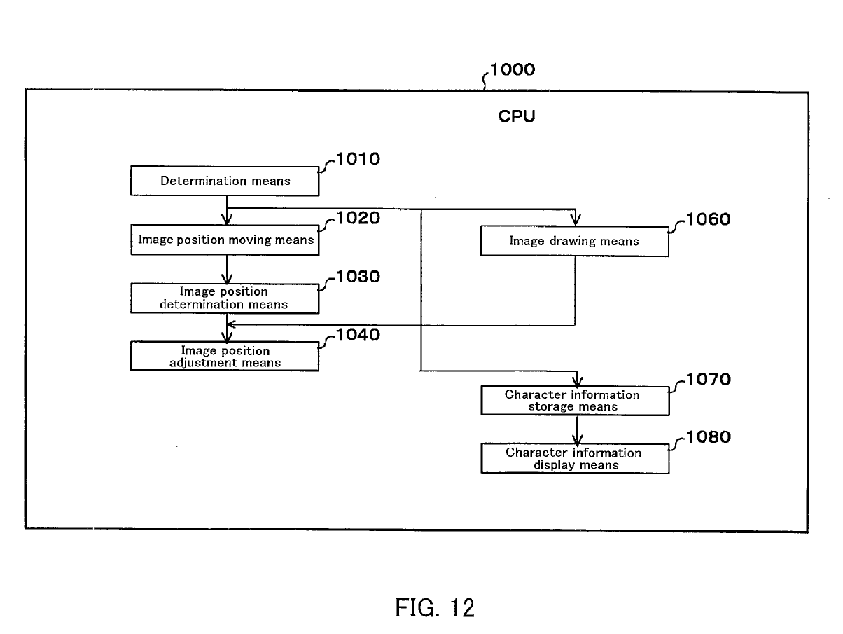

### DESCRIPTION OF SYMBOLS

10, 20: router
11-13, 21-23: L3 switch
25-27: L2 switch
28-30: server

1. A network diagram display device comprising:
a first display means for displaying various nodes in a manner of allowing the identification of the classification thereof;
a second display means for displaying the physical connection part between the foregoing nodes; and
a third display means for displaying the logical connection part within the nodes.

2. The network diagram display device as claimed in claim 1, comprising means for displaying connecting lines that connect the display part of the foregoing each node, the display part of the foregoing physical connection and the display part of the foregoing logical connection.

3. The network diagram display device as claimed in claim 1, comprising means for increasing and decreasing the display part of the foregoing physical connection and the foregoing logical connection.

4. The network diagram display device as claimed in claim 1, comprising means for adjusting each other's display position of said icon images, when an instruction was made so that the destination of the display position of the icon image indicative of the foregoing node becomes to be on an icon image of another classification, and then confirming the display position of the target icon image to be moved; and means for confirming the display position of said target icon image to be moved without performing the foregoing adjustment, when an instruction was made so that the destination of the display position of the icon image indicative of the foregoing node does not become to be on an icon image of another classification.

5. The network diagram display device as claimed in claim 1, comprising means for performing the drawing of the foregoing connecting line with any one of the icon images indicative of the foregoing nodes as a start point; means for informing of terminable port icon images for the foregoing connecting line; means for performing the foregoing drawing until a port icon to be an actual terminal point of the foregoing connecting line is specified among the foregoing terminable port icon images; and means for adjusting the display positions of the terminal point of the foregoing connecting line and the port icon of the foregoing terminal point, after said specification, and then confirming said positions.

6. A program for making a computer perform:
a step for displaying various nodes in a manner of allowing the identification of the classification thereof;
a step for displaying the physical connection part between the foregoing nodes; and
a step for displaying the logical connection part within the nodes.

7. A recording medium, wherein the program as claimed in claim 6 is recorded.
